(19) United States
(12) Patent Application Publication
(10) Pub. No.: US 2009/0082000 A1
(43) Pub. Date: Mar. 26, 2009

(54) Communications system

(75) Inventors: Hiroshi Nakano, Akishima-shi (JP); Yusuke Kanahashi, Hamura-shi (JP); Michitomo Suzuki, Hamura-shi (JP)

Correspondence Address: OLIFF & BERRIDGE, PLC, P.O. BOX 320850, ALEXANDRIA, VA, 22320-4850, US

(73) Assignee: HITACHI KOKUSAI ELECTRIC INC., TOKYO (JP)

(21) Appl. No.: 12/230,670

(22) Filed: Sep. 3, 2008

(30) Foreign Application Priority Data
Sep. 25, 2007 (JP) 2007-246577

(51) Int. Cl. H04M 3/00

(52) U.S. Cl. 455/418

(57) ABSTRACT

A second software radio set requests a first software radio set to send a profile analysis result of the second software radio set. If it is stored in the first software radio set, the second software radio set composes an update application delivered from an update server using the profile analysis result received. If not, the second software radio set itself performs a profile analysis and composes the update application using a result of the profile analysis. The second software radio set sends the profile analysis result to the first software radio set and has it stored in the first software radio set.

### BACKGROUND OF THE INVENTION

1. Field of the Invention

The present invention relates to a communications system including communications devices each of which performs, by running a program, processing that is necessary for a communication.

2. Description of the Related Art

For example, JP-T-2002-517121 (the symbol “JP-T” as used herein means a published Japanese translation of a PCT application) discloses a method for performing communication using signals having various kinds of waveforms by performing software-like processing.

In this method, it is necessary for each radio set to have pieces of software corresponding to respective waveforms. For example, if it is intended to apply this method to plural kinds of radio sets having different hardware configurations (e.g., processors used), it is necessary to develop software for each kind of radio set and waveform.

### SUMMARY OF THE INVENTION

The present invention has been made in the above circumstances, and an object of the invention is therefore to provide a communications system which is improved so as to be able to easily update software of a radio set which performs, through software-like processing, processing that is necessary for a communication.

To attain the above object, the invention provides a communications system having plural communications devices which are connected to each other via a network to be used for update of programs and which perform processing that is necessary for communication by running programs, wherein the plural communications devices include one or more first communications devices and one or more second communications devices; each of the first communications devices and the second communications devices has profiles that are necessary for generating a program and one or more constituent sections that are necessary for running the program; each of the first communications devices comprises profile analyzing means that performs a profile analysis on respective constituent sections of the first communications device; profile storing means that stores profiles of the first communications device acquired by the profile analyzing means and profiles sent from each of the second communications devices; profile sending means that sends the profiles of a second communications device to the second communications device over the network in response to a request that is sent from the second communications device over the network, if the requested profiles are stored in the first communications device; and first program composition means that, when a program has been updated, composes the updated program and renders it executable by using the profiles of the first communications device acquired by the profile analyzing means or stored in the first communications device; and each of the second communications devices comprises profile analyzing means that performs a profile analysis on respective constituent sections of the second communications device; profile communicating means that communicates the profiles acquired by the profile analyzing means to the first communications device or devices; profile requesting means that requests the first communications device or devices to send profiles of the second communications device when a program has been updated; and second program composition means that, when the program has been updated, composes the updated program and renders it executable by using the profiles of the second communications device acquired by the profile analyzing means or sent from a first communications device in response to a request issued by the profile requesting means.

The communications system according to the invention can easily update software of a radio set which performs, through software-like processing, processing that is necessary for a communication.

### BRIEF DESCRIPTION OF THE DRAWINGS

FIG. 1 shows the configuration of a software radio system according to the present invention;

FIG. 2 shows the hardware configuration of a first software radio set shown in FIG. 1;

FIG. 3 shows the hardware configuration of each second software radio set shown in FIG. 1;

FIG. 4 illustrates the structure of an update application which is delivered from an update server shown in FIG. 1 to the first software radio set and the second software radio sets via an inter-software ratio set network;

FIG. 5 shows the structure of a first application composition program which is run by an application composition section of the first software radio set shown in FIGS. 1 and 2;

FIG. 6 shows the structure of a second application composition program which is run by an application composition section of each second software radio set shown in FIGS. 1 and 3;

FIG. 7 illustrates a profile analysis result generated by the application composition program shown in FIG. 5 or 6;

FIG. 8 is a flowchart of the entire process (S10) for composing an update application which is executed in the first software radio set shown in FIG. 2; and

FIG. 9 is a flowchart of the entire process (S12) for composing an update application which is executed in each second software radio set shown in FIG. 3.

### DETAILED DESCRIPTION OF THE INVENTION

A software radio system 1 according to the present invention will be hereinafter described.

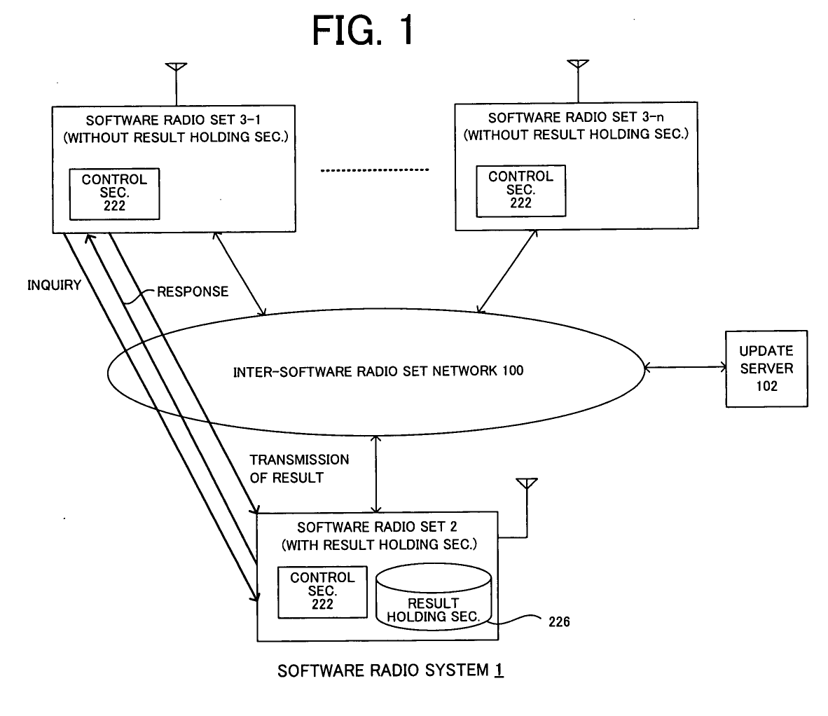

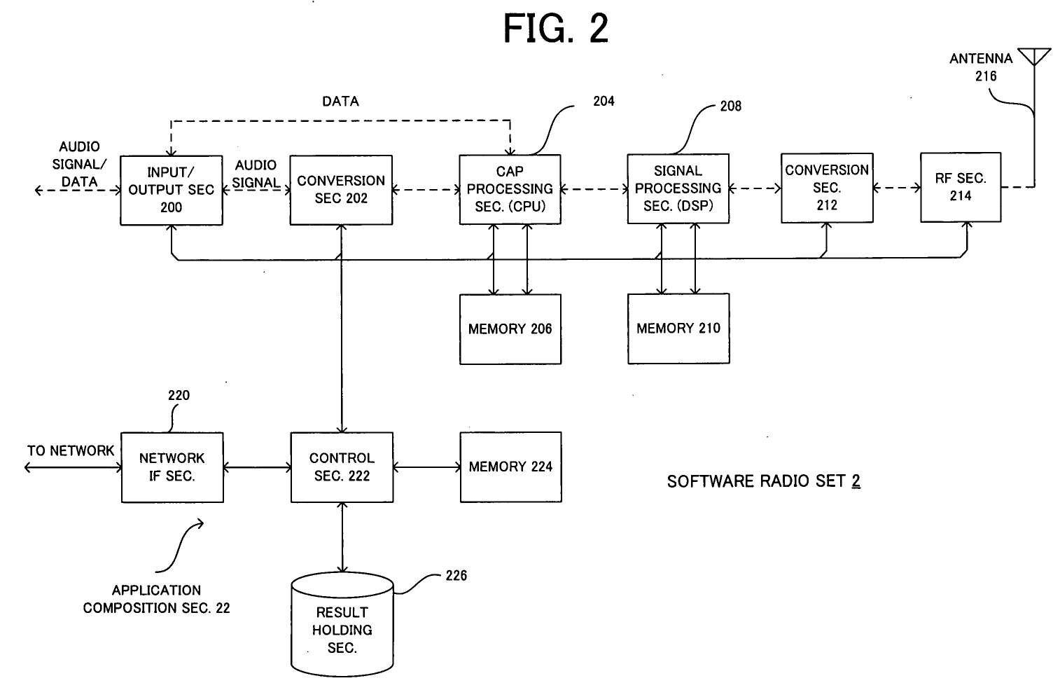

FIG. 1 shows the configuration of the software radio system 1 according to the invention. As shown in FIG. 1, the software radio system 1 is configured in such a manner that one or more first software radio sets 2 (in the example of FIG. 1, one first software radio sets 2 is provided) having a result holding section 226 (described later with reference to FIG. 2), n second software radio sets 3-1 to 3-n (n≧1) having no result holding section 226, and an update server 102 are connected to each other via an inter-software radio set network 100.

In the following description, one (not a specific one) of possibly plural constituent devices etc. such as the second software radio sets 3-1 to 3-n may be referred to simply as a second software radio set 3, for example.

In the software radio system 1, radio communications are performed between the first software radio set 1 and the second software radio sets 3 and applications of the first software radio set 1 and the second software radio sets 3 are updated online via the inter-software radio set network 100 by these constituent sections.

### Hardware

FIG. 2 shows the hardware configuration of the first software radio set 2 shown in FIG. 1. As shown in FIG. 2, the first software radio set 2 is composed of an input/output section 200, conversion sections 202 and 212, a communication application (CAP) processing section 204, memories 206 and 210, a signal processing section 208, an RF section 214, an antenna 216, and a first application composition section 22.

The first application composition section 22 is composed of a network interface (network IF) section 220, a control section 222, a memory 224, and a result holding section 226.

It is noted that in the drawings substantially the same components or pieces of processing are given the same reference symbol.

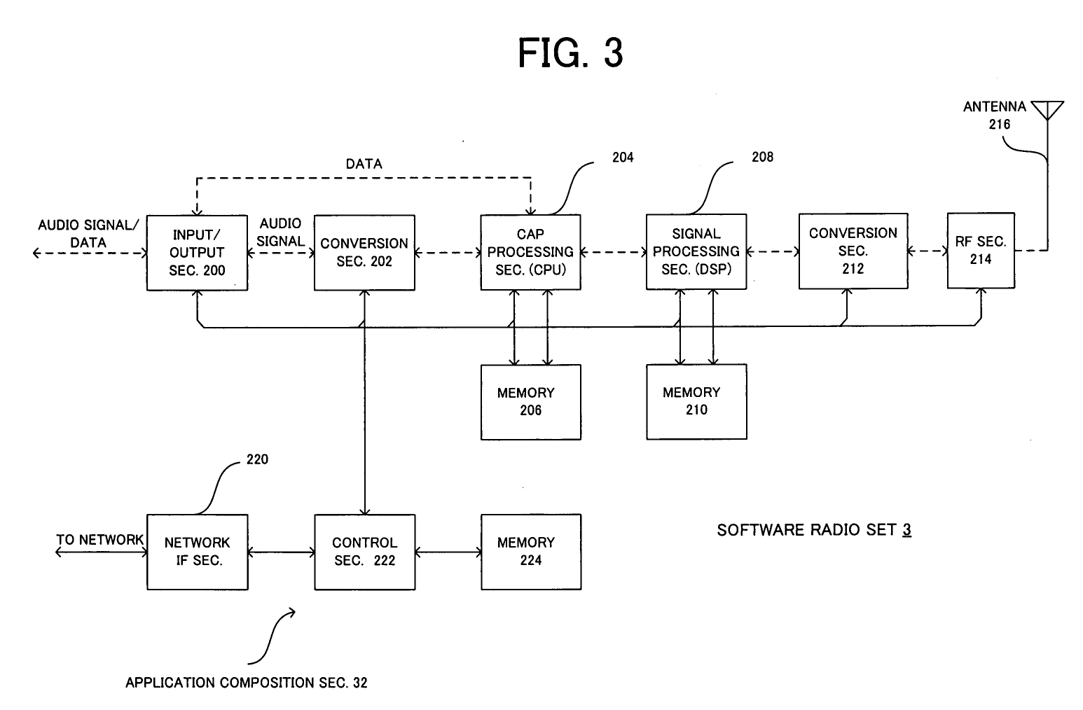

FIG. 3 shows the hardware configuration of each second software radio set 3 shown in FIG. 1. As shown in FIG. 3, each second software radio set 3 has the same configuration as the first software ratio set 2 except that the first application composition section 22 is replaced by a second application composition section 32. The second application composition section 32 is the same as the first application composition section 22 except that the result holding section 226 is removed.

In FIGS. 2 and 3, a flow of a signal or data is indicated by a broken line and a flow of processing for application update is indicated by a solid line.

The above constituent sections of each of the first software radio set 2 and the second software radio sets 3 perform a radio communication with communication processing realized by a program.

Each of the first software radio set 2 and the second software radio sets 3 performs a profile analysis on its individual constituent sections.

The first software radio set 2 composes an update application that is supplied from the update server 102 on the basis of a profile analysis result.

The first software radio set 2 receives a profile analysis result from each second software radio set 3 and stores it. In response to a request from a second software radio set 3, the first software radio set 2 returns a profile of the request source second software radio set 3 to the second software radio set 3.

Each second software radio set 3 communicates a profile analysis result to the first software radio set 2.

Each second software radio set 3 composes an update application that is supplied from the update server 102 on the basis of a result of a profile analysis performed by the second software radio set 3 or a profile analysis result returned from the first software radio set 2 in response to a request.

In the first software radio set 2, the input/output section 200 receives an analog signal such as an audio signal and outputs it to the conversion section 202. Furthermore, the input/output section 200 outputs, to the outside, an analog signal received from the conversion section 202. Still further, the input/output section 200 receives or outputs digital data to be input to or received from the communication application processing section 204 from or to the outside such as a host computer (not shown).

The conversion section 202 performs analog-to-digital (A/D) conversion on an analog signal received from the input/output section 200 and outputs a resulting digital signal to the communication application processing section 204. Furthermore, the conversion section 202 performs digital-to-analog (D/A) conversion on data received from the communication application processing section 204 and outputs a resulting analog signal to the input/output section 200.

Composed of a CPU etc., the communication application processing section 204 runs a program for communication processing (e.g., error correction) that is stored in the memory 206.

Composed of a DSP etc., the signal processing section 208 runs a program for communication processing (e.g., modulation and demodulation) that is stored in the memory 210.

The conversion section 212 D/A-converts a digital signal received from the signal processing section 208 and outputs a resulting intermediate frequency signal to the RF section 214. Furthermore, the conversion section 212 A/D-converts an intermediate frequency signal received from the RF section 214 and outputs a resulting digital signal to the signal processing section 208.

The RF section 214 converts an intermediate frequency signal received from the conversion section 212 into a high-frequency transmission signal whose frequency and power are suitable for a radio communication line (not shown) and transmits it to the radio communication line via the antenna 216. Furthermore, the RF section 214 amplifies a high-frequency reception signal received from the radio communication line via the antenna 216 and outputs a resulting intermediate frequency signal to the conversion section 212.

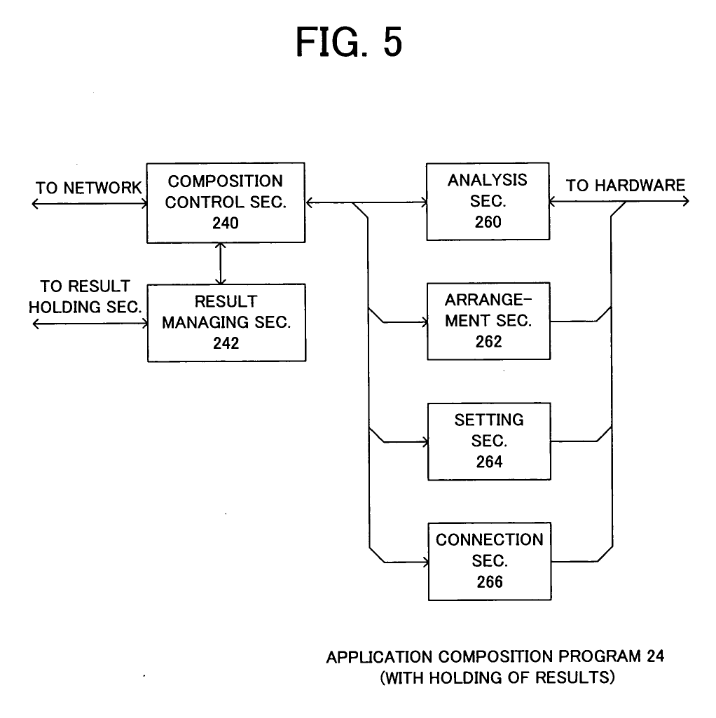

Composed of a CPU etc., the control section 222 of the first application composition section 22 composes a program updated by the update server 102 by running an application composition program 24 (described later with reference to FIG. 5) that is stored in the memory 224.

The network IF section 220 performs processing that is necessary for exchange of necessary data between the inter-software radio set network 100 and the control section 222.

The result holding section 226 holds results of profile analyses performed in the first software radio set 2 and the second software radio sets 3 and supplies them to the control section 222 for processing performed therein.

Depending on the configuration of the first software radio set 2, the CPU included in the communication application processing section 204 and the CPU included in the control section 222 may be a common CPU and the memories 206 and 224 may be a common memory.

### Software

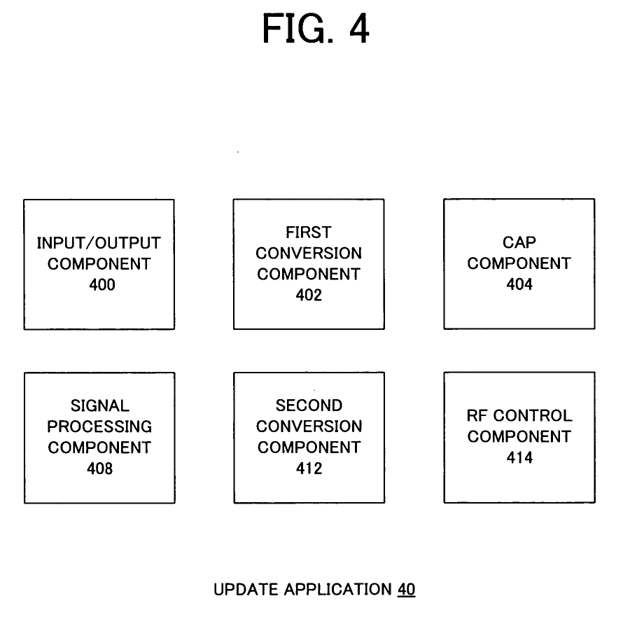

FIG. 4 illustrates the structure of an update application 40 which is delivered from the update server 102 shown in FIG. 1 to the first software radio set 2 and the second software radio sets 3 via the inter-software ratio set network 100.

The update application 40 is a set of components; for example, it is composed of an input/output component 400 for controlling the input/output section 200 (see FIGS. 2 and 3), a first conversion component 402 for controlling the first conversion section 202, a communication application (CAP) component 404 which is stored in the memory 206 and executed by the communication application processing section 204, a signal processing component 408 which is stored in the memory 210 and executed by the signal processing section 208, a second conversion component 412 which controls the second conversion section 212, and an RF control component 414 which controls the RF section 214.

FIG. 5 shows the structure of an application composition program 24 which is run by the first application composition section 22 of the first software radio set 2 shown in FIGS. 1 and 2. As shown in FIG. 5, the first application composition program 24 is composed of a composition control section 240, a result managing section 242, an analysis section 260, an arrangement section 262, a setting section 264, and a connection section 266.

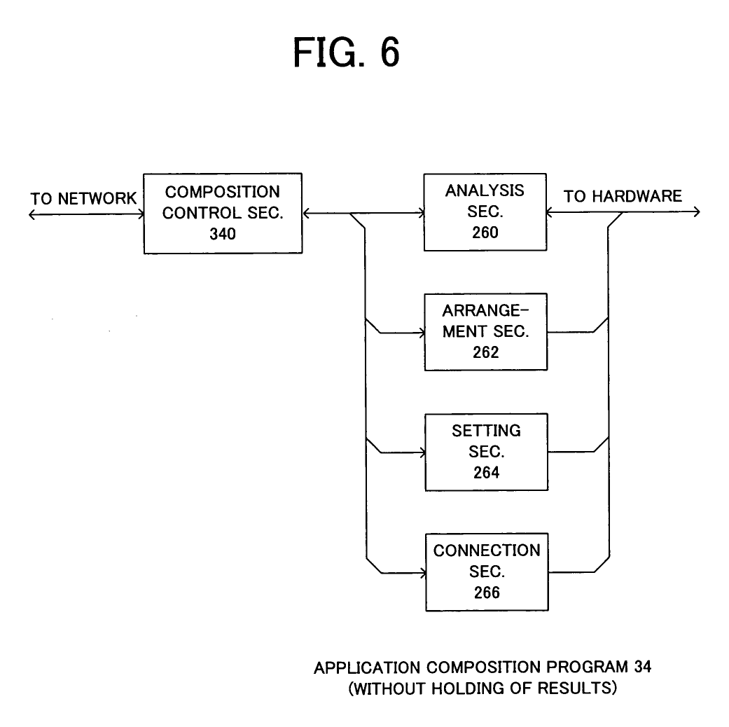

FIG. 6 shows the structure of an application composition program 34 which is run by the second application composition section 32 of each second software radio set 3 shown in FIGS. 1 and 3. As shown in FIG. 6, the second application composition program 34 is the same as the first application composition program 24 except that the result managing section 242 is removed and the first composition control section 240 is replaced by a second composition control section 340.

Having the above constituent sections, the first application composition program 24 performs the above-described processing, that is, performs a profile analysis, composes an update application, stores a profile analysis result generated in the first software radio set 2 itself or supplied from a second software radio set 3, and sends a profile analysis result in response to an inquiry from a second software radio set 3 (see FIG. 1).

Having the above constituent sections, each second software radio set 3 performs the above-described processing, that is, performs a profile analysis, composes an update application, requests the first software radio set 2 to send a profile analysis result of the first software radio set 2 itself, and sends a profile analysis result to the first software radio set 2 (also see FIG. 1).

As for the constituent sections common to the first application composition program 24 and the second application composition program 34, the constituent sections of the first application composition program 24 will be described below to avoid redundant description. Basically, the individual constituent sections of the second application composition program 34 having the corresponding constituent sections bearing the same reference numerals in the first application composition program 24 perform the same processing as the latter.

The composition control section 240 (see FIG. 5) of the first application composition program 24 receives an update application (see FIG. 4) from the update server 102 and composes the update application by controlling the constituent sections of the first application composition program 24.

The term “composing an update application” means an operation that when receiving an update application from the update server 102 the first software radio set 2 or each second software radio set 3 (see FIG. 2 or 3) properly sets the components (see FIG. 4) of the update application according to profile analysis results of the respective constituent sections and thereby renders them executable.

When receiving a profile analysis result from a second software radio set 3 or acquiring a result of a profile analysis performed in the first software radio set 2, the first composition control section 240 stores the profile analysis result in the result holding section 226 (see FIG. 2) via the result managing section 242.

Furthermore, when a request for sending a profile analysis result stored in the result holding section 226 is received from a second software radio set 3 and this profile analysis result is stored in the result holding section 226, the first composition control section 240 reads the requested profile analysis result from the result holding section 226 via the result managing section 242 and sends it to the request source second software radio set 3.

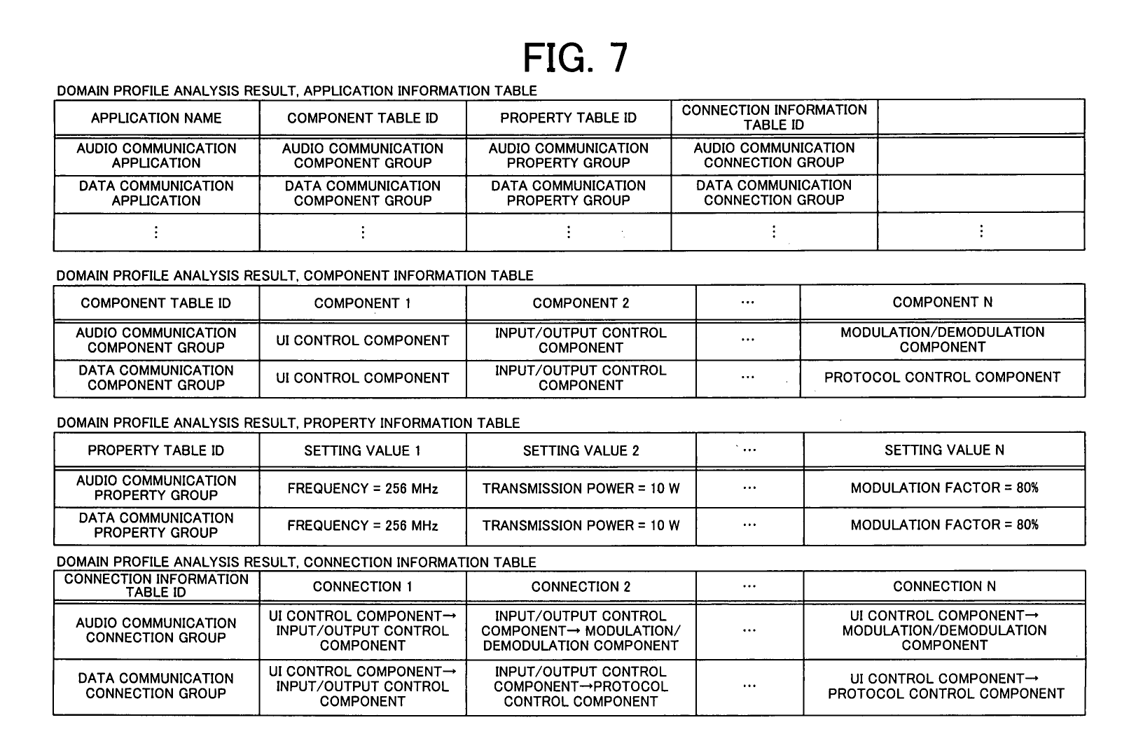

FIG. 7 illustrates a profile analysis result generated by the application composition program 24 or 34 shown in FIG. 5 or 6. It is noted that the components shown in FIG. 4 and the profile analysis result illustrated in FIG. 7 have no direct relationships and the terms used in these drawings are not necessarily consistent.

The analysis section 260 analyses the profiles of the respective constituent sections of the first software radio set 2 under the control of the first composition control section 240, obtains a result as illustrated in FIG. 7, and outputs it to the composition control section 240.

More specifically, the analysis section 260 combines pieces of component information in profiles divided into plural files, compares component specifications (e.g., a clock frequency and a memory size) indicated by the profile information with each specification of the constituent sections, and judges whether the software is executable.

As shown in FIG. 7, a profile analysis result (domain profile analysis result) is generated for each update application and includes an application information table, a component information table, a property information table, and a connection information table.

The application information table includes application names for identification of respective applications, component table IDs each for identification of components (see FIG. 4) included in the corresponding application, property table IDs each indicating properties of the respective constituent sections of the software radio set 2 or 3 that are set in the respective components to render the components executable, and connection information table IDs each indicating pieces of connection information that are used for communication between components.

The component information table includes component table IDs indicating relationships with the application information table and components 1-N indicating belonging components.

The properly information table includes property table IDs indicating relationships with the application information table and properties 1-N indicating setting values for the respective components.

The connection information table includes connection information table IDs indicating relationships with the application information table and connections 1-N that are pieces of connection information including directions of communication between the components.

The arrangement section 262 (see FIG. 5) arranges the components using the information that is contained in the component information table.

For example, where the update application includes the components shown in FIG. 4, the arrangement section 262 arranges the input/output component 400, the first conversion component 402, the second conversion component 412, and the RF control component 414 in the memory 224 of the first software radio set 2 (see FIG. 2) and thereby allow the control section 222 to control the operations of the input/output section 200, the conversion sections 202 and 212, and the RF section 214 by executing these components.

Furthermore, the arrangement section 262 arranges the communication application processing component 404 and the signal processing component 408 in the memories 206 and 210, respectively, of the first software radio set 2 and thereby allows these components to be executed by the communication application processing section 204 and the signal processing section 208, respectively.

The setting section 264 sets properties of the respective constituent sections of the first software radio set 2 in the components arranged by the arrangement section 262 by using the information contained in the property information table, and thereby establishes a state that the components can operate in manners suitable for the respective constituent sections of the arrangement section 262.

The connection section 266 performs processing for connecting the components and thereby establishes a state that the components can cooperate to perform processing for a communication by the first software radio set 2.

The connection processing is processing for establishing communication means between the components and is specifically processing for establishing pieces of processing of communication means in the OSI fifth and sixth layers of CORBA.

In the second application composition program 34 (see FIG. 6), when receiving an update application from the update server 102 (see FIG. 1), the second composition control section 340 requests the first software radio set 2 to send a profile analysis result (see FIG. 7) of the second software radio set 3 concerned.

As described above, if the first software radio set 2 has the profile analysis result of the request source second software radio set 3 in the result holding section 226, the first software radio set 2 reads the profile analysis result and sends it to the second software radio set 3.

If no profile analysis result of the second software radio set 3 is received from the first software radio set 2, the second composition control section 340 controls the analysis section 260 so that it performs a profile analysis on the second software radio set 3.

The analysis section 260 to the connection section 266 of the second application composition program 34 of each second software radio set 3 perform the same processing as in the first software radio set 2.

### Entire Processes of Software Radio Sets 2 and 3

The entire processes for composing an update application which are executed in the first software radio set 2 and each second software radio set 3 will be described below.

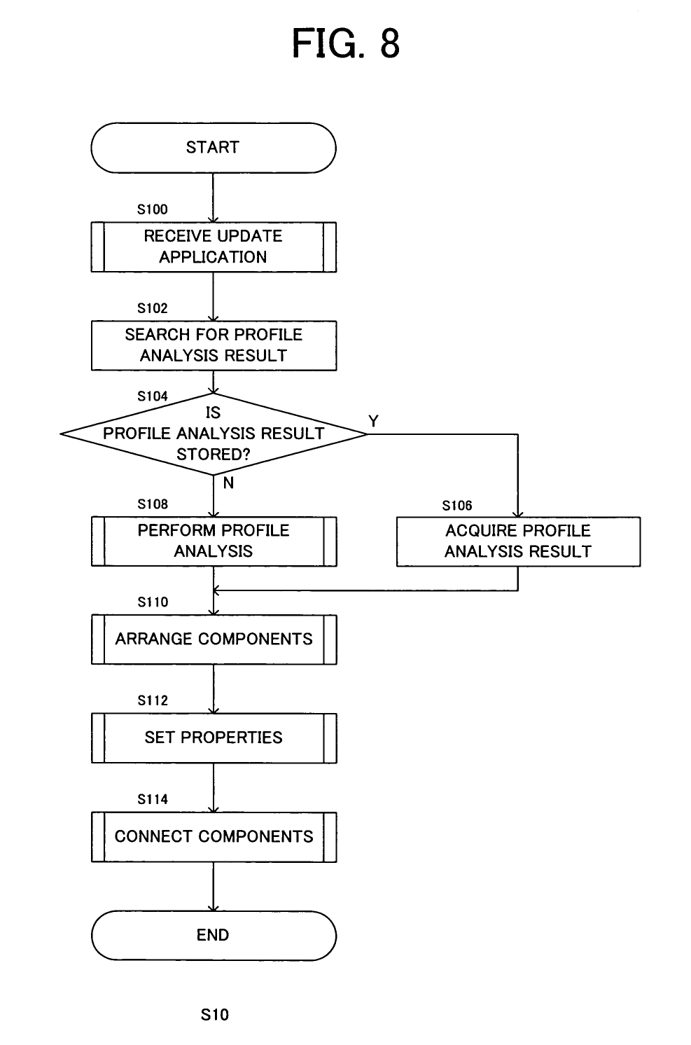

FIG. 8 is a flowchart of the entire process (S10) for composing an update application which is executed in the first software radio set 2 shown in FIG. 2.

Referring to FIG. 8, at step 100 (S100), the first software radio set 2 shown in FIGS. 1 and 2 (first application composition program 24 (see FIG. 5)) receives an update application from the update server 102.

At step 102 (S102), the first composition control section 240 of the first application composition program 24 checks, via the result managing section 242, whether a profile analysis result of the first software radio set 2 is stored in the result holding section 226 (see FIG. 2).

If judging that a profile analysis result of the first software radio set 2 is stored in the result holding section 226 (step 104 (S104): yes), the process moves to S106. If not, the process moves to S108.

At step 106 (S106), the first composition control section 240 acquires the profile analysis result of the first software radio set 2 from the result holding section 226 via the result managing section 242.

At step 108 (S108), the first composition control section 240 controls the analysis section 260 so that it performs a profile analysis on the first software radio set 2, and acquires a result.

At step 110 (S110), the arrangement section 262 arranges the components (see FIG. 4) of the update application.

At step 112 (S112), the setting section 264 sets properties of the respective constituent sections of the first software radio set 2 in the thus-arranged components.

At step 114 (S114), the connection section 266 connects the arranged, property-set components and thereby renders them executable.

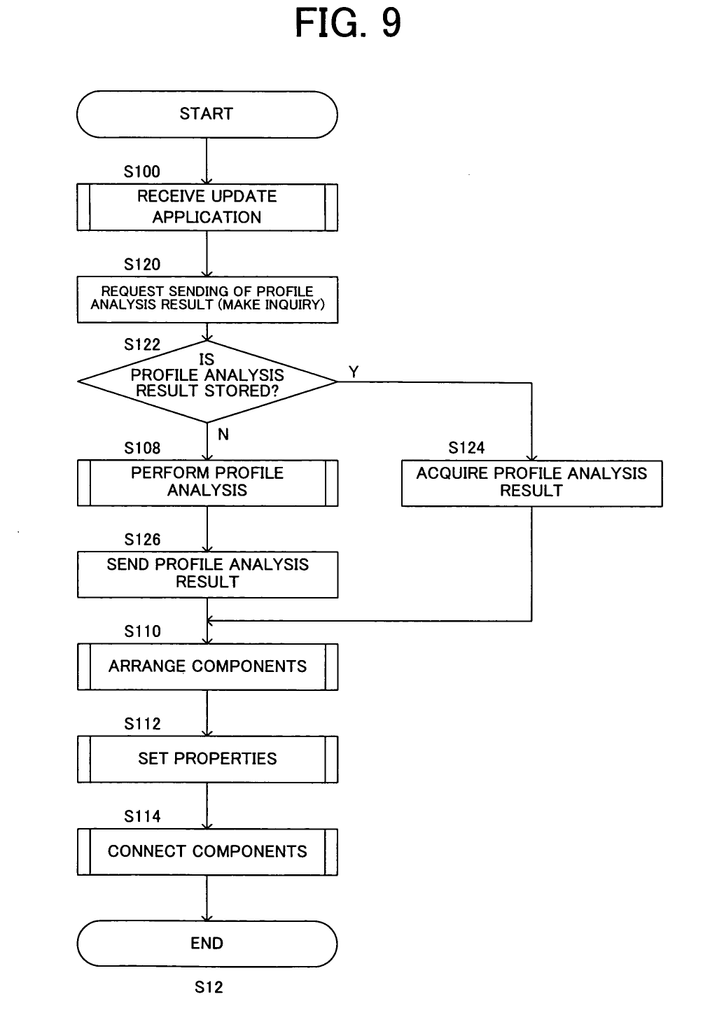

FIG. 9 is a flowchart of the entire process (S12) for composing an update application which is executed in each second software radio set 3 shown in FIG. 3.

At step 120 (S120), the second composition control section 340 of the second software radio set 3 (second application composition program 34 (see FIG. 6)) requests the first software radio set 2 to send a profile analysis result of the second software radio set 3 (i.e., makes an inquiry).

At step 122 (S122), the second composition control section 340 judges whether a profile analysis result exists in the first software radio set 2.

If judging that a profile analysis result exists in the first software radio set 2, the second application composition program 34 moves to step S124. If not, the second application composition program 34 moves to step S108.

At step 124 (S124), the second composition control section 340 acquires the profile analysis result of the second software radio set 3 from the first software radio set 2.

At step 126 (S126), the second composition control section 340 sends the profile analysis result acquired at step S108 to the first software radio set 2. The first composition control section 240 of the first software radio set 2 (first application composition program 24) receives the profile analysis result from the second software radio set 3 and stores it in the result holding section 226.

### Features of Software Radio System 1

The data amount of a profile analysis result that is stored in the result holding section 226 (see FIG. 2) does not increase according to the scale of an update application. Therefore, in the software radio system 1, an application of each of the software radio sets 2 and 3 can be updated quickly even if the scale of an update application is large.

Since a profile analysis result of each second software radio set 3 can be stored in the software radio system 1 and can be publicized, an application of each of the software radio sets 2 and 3 can be updated quickly even if the number of software radio sets 2 and 3 is increased.

Therefore, according to the above-described method, applications of the software radio sets 2 and 3 can accommodate frequent updates.

As such, the invention can be applied to update of applications of communications devices that are part of a communications system.

What is claimed is:

1. A communications system having plural communications devices which are connected to each other via a network to be used for update of programs and which perform processing that is necessary for communication by running the programs, wherein:
the plural communications devices include one or more first communications devices and one or more second communications devices;
each of the first communications devices and the second communications devices has profiles that are necessary for generating the program and one or more constituent sections that are necessary for running the program;
each of the first communications devices comprises:
profile analyzing means that performs a profile analysis on respective constituent sections;
profile storing means that stores profiles of the first communications device acquired as a result of the analysis and profiles sent from each of the second communications devices;
profile sending means that sends the profiles of a second communications device to the second communications device over the network in response to a request that is sent from the second communications device over the network, if the requested profiles are stored in the first communications device; and
first program composition means that, when the program has been updated, composes the updated program and renders it executable by using the profiles of the first communications device acquired as a result of the analysis or stored in the first communications device; and
each of the second communications devices comprises:
the profile analyzing means;
profile communicating means that communicates the profiles acquired as a result of the analysis to the first communications device or devices;
profile requesting means that requests the first communications device or devices to send profiles of the second communications device when a program has been updated; and
second program composition means that, when the program has been updated, composes the updated program and renders it executable by using the profiles of the second communications device acquired by the profile analyzing means or sent from a first communications device in response to a request issued by the profile requesting means.
